(19) United States
(12) Patent Application Publication
(10) Pub. No.: US 2005/0151518 A1
(43) Pub. Date: Jul. 14, 2005

(54) Regulated open-loop constant-power power supply

(76) Inventors: Henry D. Schneiker, Tucson, AZ (US); Peter Gransee, Mesa, AZ (US)

Correspondence Address: JANSSON, SHUPE & MUNGER, LTD, 245 MAIN STREET, RACINE, WI, 53403, US

(21) Appl. No.: 10/753,598

(22) Filed: Jan. 8, 2004

(51) Int. Cl. G05F 1/10

(52) U.S. Cl. 323/222

(57) ABSTRACT

A constant-power switching power supply has an inductor with an inductor current that remains in discontinuous conduction mode (DCM), where the power supply supplies and maintains constant output power to a load without measuring output parameters, by regulating charge-up time of the inductor. A method of maintaining a constant output power for a power supply being run in discontinuous conduction mode (DCM), having an inductor, includes obtaining a measured input voltage for voltage being input to the power supply, obtaining from a memory a set of values based on the measured input voltage, and driving a pulse width modulation (PWM) generator based on the set of values, the driving of the PWM generator thereby regulating a charge-up time of the inductor to correspond to the measured input voltage, whereby the regulating of the charge-up time of the inductor maintains an essentially constant power for a load.

### BACKGROUND

1. Technical Field

The present invention is directed generally to power conversion and, more particularly, to a switching power supply and methods that provide a constant power to a load.

2. Description of the Related Art

An inductive switching regulated power supply may be implemented in various configurations to convert an input voltage into an output voltage. Such power supplies may be classified by a type of topology being utilized. For example, topologies may include buck, boost, buck-boost, single-ended parallel inductor converter (SEPIC), and Cuk. Such configurations may include a switch, diode, inductor, and capacitor. A particular topology may be selected, for example, based on a transfer function desired for a given application. In general, a buck type circuit has an output voltage (Vo) less than an input voltage (Vi), a boost type circuit has a Vo greater than a Vi, and a buck-boost type circuit has a Vo that can be greater than or less than a Vi. These three topologies may provide the basis for other topologies that include an inductor. For example, either a SEPIC or Cuk topology is generally considered to be a boost stage followed by a buck stage, with redundant parts removed. By analogy, such a removal of redundant parts is similar to reducing a complicated math formula and reducing it to a simpler form. The vast majority of inductor power supplies employ either the buck or boost topology. A typical application for a buck-boost topology is a flyback configuration used for generating isolated high voltages, such as for television picture tubes.

Generally, a current conduction mode of operation of a switching power supply is either a continuous conduction mode (CCM) or a discontinuous conduction mode (DCM). “Continuous” is used in this context to refer to inductor current. It is also possible to operate a switching power supply at a critical conduction point between CCM and DCM, by use of a feedback signal that monitors the remaining current of an inductor coil so that the power supply switches its power switch at or near the same time as the inductor's current drops to zero. Such a configuration is known as a self-oscillating switching power supply.

Continuous mode is a desirable operating condition since it typically achieves low peak inductor currents, low ripple currents, and high efficiency with a small amount of electrical noise, compared with a non-continuous mode power supply. A continuous mode operation may typically have a self-regulating output voltage. However, as discussed further below, continuous mode operation is not always possible or desirable. In continuous mode, inductor topologies typically exhibit a self-regulating tendency such that, for a known input voltage and a known duty cycle (ratio of on-time to total time period) the output voltage is also known. The exact transfer function may differ from one topology to the next, but the transfer function is only dependent on input voltage and duty cycle. Therefore, a power supply operated in continuous mode acts like a voltage source and will supply any amount of current needed to maintain the designed output voltage. As the load draws more current it also lowers the output voltage, which causes the inductor current to increase until the designed output voltage is achieved. As the load draws less current it also raises the output voltage, which causes the inductor current to decrease until the nominal output voltage is achieved.

A non-continuous (discontinuous) mode exists when the inductor current of an inductor type switching power supply stays at zero for a portion of a switching cycle. The corresponding power supply circuit typically has a diode that allows only unidirectional current flow, so that when the output load current falls below a critical current level, if the inductor current attempts to fall below zero, it just stops at zero. This is shown by way of example in FIG. 1, where it can be seen that three unique states are present for an inductor current in a given switching cycle of an inductor type switching power supply, the ON, DISCHARGE, and IDLE states. In the IDLE state, the inductor current remains at zero until the start of a next cycle. As can be seen in FIG. 1, the output current Io is inverted for the buck-boost topology.

In non-continuous mode, the output voltage typically is not self-regulating since the inductor current goes to zero each cycle. Therefore, a discontinuous mode topology power supply acts like a constant power source and will supply the amount of voltage needed to maintain the designed power. If the output current demand increases, the output voltage correspondingly decreases. If the output current decreases, the output voltage correspondingly increases. Given a fixed input voltage and inductance, a variation of some combination of duty cycle or frequency is conventionally used to compensate changes in output voltage.

An increasing use of light-emitting diodes (LEDs) for applications that previously utilized incandescent and fluorescent light sources has resulted from significant advances in semiconductor technology. Modern LEDs may have a long operating life, high shock tolerance, low profile, and high efficiency. Common LED applications include, for example, overhead lighting, vehicle lights, flashlights, and others. Electrically, LEDs are generally considered to operate in the current domain.

Power supplies are typically designed to accomplish either constant voltage or constant current. Many power supplies are of a constant voltage type employing some kind of built-in over-current protection. LED drivers may be constructed by using a voltage source together with current limiting resistors or linear current regulators. However, current limiting resistors cause power loss that results in inefficiency of an LED driver circuit, and current regulators may be imprecise. In addition, constant voltage power supplies may be inappropriate for driving LEDs because of a steep voltage/current curve and negative temperature coefficient for a given LED. In other words, such a power supply may be unstable at high power settings and may be prone to thermal runaway.

A constant current may typically be achieved by measuring a current across a resistor to generate a voltage, which is then used to regulate the output voltage until the current is within limits. Constant current is quite desirable for LEDs since they are current mode devices, but current regulation may add inefficiency and complexity to a driver circuit. Constant current circuits must also generally be carefully designed to remove inherent instabilities.

### SUMMARY OF THE INVENTION

The present invention concerns providing constant power regulation that regulates output power without measuring output parameters.

An inductor of known value develops a forward current of known value, the current value being based on an applied voltage of known value and time. The amount of energy, measured in joules, that is contained in an inductor is given by the formula:

$$Energy = \frac{{LI}^{2}}{2}$$

Therefore, if an inductor of a known value is “charged up” to a known value, the amount of energy stored in the inductor is also a known value. In a power supply circuit, the energy stored in the inductor is then “discharged” into a load (e.g., an LED) during a cycle. The output power transferred to the load is calculated by the formula:
Power=J*N*T(joules per unit time)
Therefore, by knowing only the value of the inductor and the input voltage, and by regulating the ON time (charge-up time) to correspond to the input voltage so as to store a known amount of energy, it becomes possible to regulate the output power without measuring the output parameters. This is an open-loop system. It is apparent that certain assumptions are made about the load. But by defining the load, these assumptions will always be valid.

According to one aspect of the invention, a method of regulating the output power of an inductor type switching power supply, having an input voltage and an output power, includes obtaining a value of the input voltage, and regulating the ON time (charge-up time) of the inductor to correspond to the value of the input voltage so as to store a known amount of energy in the inductor, whereby the regulating of the ON time regulates the output power without measuring output parameters of the power supply.

The method may also include defining a load for the output power being produced. The obtaining of the value of the input voltage may include measuring the input voltage. The regulating of the ON time of the inductor may include translating the value of the input voltage to obtain a set of values, generating a pulse width modulation (PWM) signal based on the set of values, and driving a switch using the PWM signal. The switch may be part of a buck-boost power supply.

A calibration may be performed (e.g., in a production environment) in order to account for device tolerances. A calibrating may include adjusting of a time constant so that calculated or theoretical values more closely match real values, thereby allowing given desirable operating characteristics of an inductor type switching power supply to be obtained.

Various implementations and embodiments of the invention are envisaged. For example, synchronous rectification may be used to increase the efficiency of an inductor type switching power supply. Another example is a use of a microprocessor or similar device for performing voltage measurement, table lookup, PWM generation, etc.

A number of potential applications exist for constant-power power supplies, such as for driving arc lights, lasers, welders, or LEDs. However, conventionally most of these applications do not truly use constant power designs but instead utilize constant current designs or limited current power supply designs. This is especially so when high power is required by a given application. These designs also typically employ continuous mode operation. The present inventors have determined that if it is necessary to measure the output voltage and/or current and to provide a closed-loop feedback mechanism, there is little or no benefit in such a case in utilizing a constant power operation compared with a constant current operation.

Additionally, the invention may be applied to various other applications such as general lighting, communications, architectural lighting, forensic lighting systems that generate light of specific colors and spectra, police and military applications, health services applications, and others. For example, a PWM of the present invention may be adapted to provide an output PWM waveform having specific characteristics, such as particular ratios of ON/OFF time for a given function or effect, to provide for various levels of clock resolution that may, for example, guarantee a minimum or maximum ON time, etc.

The present inventors have determined that constant power regulation that regulates output power without measuring output parameters may be employed for certain applications. For example, in non-continuous mode, the transfer function for a buck-boost topology becomes dependent on input voltage, inductance, duty cycle, frequency, and load resistance. Therefore, if these parameters are controlled and/or their tolerances are accounted-for, then a constant power may be obtained without measuring output parameters.

For example, a closed-loop type of power supply may typically utilize a sense resistor or similar apparatus for sensing an overcurrent, measuring an output current, measuring an output voltage, etc. In such a case, an elimination of the sense resistor and associated electronics, or similar apparatus, may provide reduced weight, cost, heat, and space in a given application. By eliminating a power consumption of such a sense resistor, the efficiency may be increased.

For example, when a method and apparatus for supplying electric power are implemented for driving at least one light emitting diode (LED) in a flashlight, the elimination of a feedback device such as a sensing resistor may result in significant improvements. Eliminating the cost, size and weight of, and the heat generated by, such a sensing resistor and associated electronics may be especially significant when the particular application is a miniature LED type flashlight. In addition, regardless of other considerations, such a sensing resistor or similar apparatus may also be relatively expensive depending on various factors such as accuracy and tolerances, performance characteristics, temperature effects, reliability, etc.

A constant power, switching power supply may include an inductor with an inductor current that remains in discontinuous conduction mode (DCM), where the power supply is operative to supply and maintain constant output power to a load without measuring output parameters, by regulating charge-up time of the inductor.

The power supply may include a voltage measurement unit operative to measure an input voltage being provided to the power supply, and a pulse-width modulation (PWM) generator operative to perform the regulating of the charge-up time based on the measured input voltage. The power supply has an input voltage and may be configured in a buck-boost topology. The power supply may also include a calculation unit for translating the input voltage into a set of values or, alternatively, a look-up table for translating the input voltage into a set of values, and a pulse-width modulation (PWM) generator operative to perform the regulating of the charge-up time based on the set of values. The calculation unit may be integral with a measurement unit and/or with a PWM generator. The power supply may include a voltage measurement unit structured for periodically measuring the input voltage, wherein the set of values is updated for each periodically measured input voltage. The power supply may include a switch and a pulse width modulation (PWM) generator operative to drive the switch, thereby effecting the regulating, the power supply having a buck-boost topology. A voltage measurement unit may be structured for periodically obtaining a measured input voltage, where the driving of the switch is based on the periodically-measured input voltage. The power supply may include at least one battery that supplies the input voltage to the voltage measuring unit. The power supply supplies essentially constant power to a load as a series of pulses, and may include a capacitor disposed in parallel with the load to smooth the output voltage. The power supply may include a diode disposed in series with a current being supplied by the inductor to the load. The load may be a semiconductor device such as, for example, at least one light emitting diode (LED). The power supply may include a memory such as, for example, a look-up table, operative to translate the measured input voltage into a set of values. The memory may include a processor.

An apparatus may include a voltage source that provides a voltage having polarity of plus and minus, and a constant-power power supply having a buck-boost topology and including: a switch having a first terminal and a second terminal, the switch connected to the plus voltage at the first terminal; an inductor having one end connected to the second terminal of the switch and having an other end; a capacitor having one end connected to the one end of the inductor and having an other end; a diode having an cathode connected to the other end of the capacitor and having a anode connected to the other end of the inductor and to the minus voltage; a control box operative to obtain a value based on a measurement of the voltage, and to operate the switch for regulating charge-up time of the inductor based on the value; and a load connected across the capacitor, where the inductor has an inductor current that remains in discontinuous conduction mode (DCM), and where the regulating of the charge-up time of the inductor provides an essentially constant power to the load.

In another aspect of the invention, a power supply for supplying power to one or more LEDs may include an inductor, means for measuring input voltage being applied to the power supply, means for generating a pulse width modulation (PWM) signal based on the measured input voltage, the PWM signal having in a cycle of operation an ON portion, an OFF portion, and an IDLE portion, means for storing energy in the inductor during the ON portion, means for discharging energy from the inductor to the one or more LEDs during the OFF portion, and a load that receives the energy discharged from the inductor as output power of the power supply, where the means for storing energy in the inductor effects regulating of the output power without measuring output parameters of the power supply.

A method of maintaining a constant output power for a power supply being run in discontinuous conduction mode (DCM), having an inductor, may include obtaining a measured input voltage for voltage being input to the power supply, obtaining from a memory a set of values based on the measured input voltage, and driving a pulse width modulation (PWM) generator based on the set of values, the driving of the PWM generator thereby regulating a charge-up time of the inductor to correspond to the measured input voltage, where the regulating of the charge-up time of the inductor maintains an essentially constant power for a load.

The obtaining of the set of values from the memory may include accessing a look-up table for translating the measured input voltage. In the preferred embodiment, the power supply has a buck-boost topology and the load includes one or more LEDs.

The method may include measuring input voltage being applied to the power supply, generating a pulse width modulation (PWM) signal based on the measured input voltage, the PWM signal having in each cycle of operation an ON portion, an OFF portion, and an IDLE portion, storing energy in the inductor during the ON portion, and discharging energy from the inductor to the one or more LEDs during the OFF portion, whereby the storing of energy in the inductor effects regulating of output power being supplied to the one or more LEDs without measuring output parameters of the power supply. The generating may include controlling durations of the ON and OFF portions of the PWM signal cycles. The method may include a controlling the frequency of the PWM signal based on the measured input voltage. Although cumbersome and impractical, it is also possible to employ the method in a power supply having a boost topology.

A method of regulating the output power of an inductor type switching power supply, the power supply having an input voltage, may include obtaining a value of the input voltage, and regulating the ON time (charge-up time) of the inductor to correspond to the value of the input voltage so as to store a certain amount of energy in the inductor, whereby the regulating of the ON time of the inductor effects regulating of the output power without measuring output parameters of the power supply.

The method of regulating the output power may include determining the certain amount of energy that corresponds to a particular input voltage by defining a load for the output power being produced. The obtaining of a value of the input voltage may include measuring the input voltage. The regulating of the ON time of the inductor may include translating the value of the input voltage to obtain a set of values, generating a pulse width modulation (PWM) signal based on the set of values, and driving a switch using the PWM signal. The method of regulating may include adjusting the translating based on a determination of at least one time constant value for the power supply. Such a time constant value may be based on an inductance value of the inductor.

A method of providing electric power to a semiconductor device may include providing an open loop power supply configured in a buck-boost topology and having a shunt inductor, measuring an input voltage of the power supply, providing a translator that is operative to translate the measured input voltage into a set of values, and adjusting a duty cycle of the electric power being provided to the semiconductor device based on the set of values.

A method of controlling a constant power, switching power supply that operates in an open-loop configuration, the power supply having a switch that is turned on and off by pulse width modulation (PWM), may include graphing a value to obtain a first waveform, adding a line to the first waveform representing the input voltage, determining the time when the first waveform is above or below the line as being a PWM waveform, and outputting the PWM waveform. The determining of time may include detecting using a comparator, and the graphing may include applying a scaling factor to the first waveform.

A preferred embodiment of the invention utilizes a constant-power power supply in an LED type flashlight, the invention being especially suited for applications having a diode type of load.

A method for calibrating a constant-power switching power supply according to the invention includes comparing a timing source having a known frequency to the PWM time base, thereby obtaining at least one time correction factor. The calibrating may include applying an input voltage having a known value to the power supply and computing a voltage correction factor based on a difference between the known value and a value obtained from the voltage measurement unit. The comparing may include timing a high speed clock using a slow speed clock. The calibrating method may be a self-contained operation not requiring external hookups. The method of calibrating may include determining hardware settings for the power supply based on the at least one time correction factor. The method of calibrating may include retaining the hardware settings and using the hardware settings to setup the PWM time base whenever the controller is restarted. The method of calibrating may include adjusting the measured voltage reading by a factor that compensates for a value of the inductor, thereby changing an ON time of the inductor.

In another aspect of the invention, a method is used for calibrating a flashlight having a buck-boost power supply that operates in discontinuous conduction mode (DCM) and that includes at least one light emitting diode (LED) as its source of illumination, the method including positioning a brightness measurement unit to oppose the at least one LED, varying an operating parameter of the power supply, obtaining a brightness measurement of the at least one LED from the brightness measurement unit, and repeating the varying and obtaining until a predetermined condition is met.

The foregoing summary does not limit the present invention, which is defined by the appended claims.

### BRIEF DESCRIPTION OF THE DRAWING FIGURES

FIG. 1 shows an inductor current in a non-continuous conduction mode and an output current, for a conventional buck-boost topology.

FIG. 2 shows a highly schematic configuration of a conventional power supply control loop.

FIG. 3 shows a highly schematic configuration of a power supply having an open loop configuration.

FIG. 4 illustrates how an input voltage is measured in an exemplary embodiment of the present invention.

FIG. 5 shows a schematic of a power supply in a buck-boost configuration according to an exemplary embodiment of the present invention.

FIG. 6 shows a snubber circuit that may be added to the exemplary power supply of FIG. 5.

FIG. 7 is a flowchart for an exemplary calibration method for an embodiment of the present invention.

FIG. 8 is a flowchart for an exemplary pulse width modulation (PWM) operation for an embodiment of the present invention.

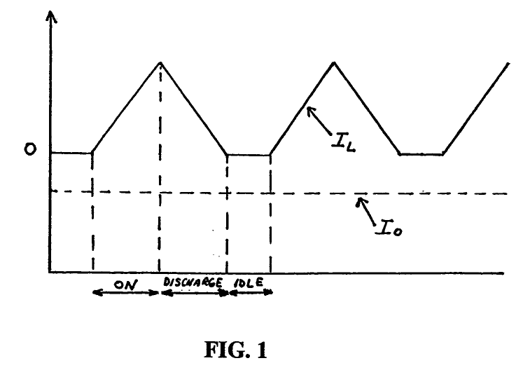

### DETAILED DESCRIPTION

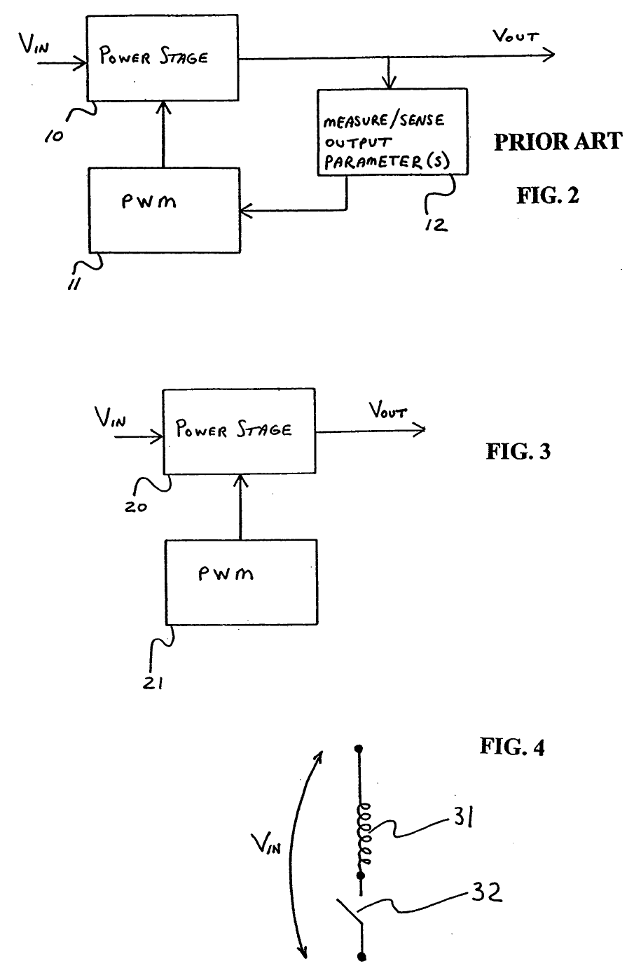

A buck-boost power stage is conventionally a part of a control loop of a buck-boost power supply. As shown in FIG. 2, such a power supply control loop includes a power stage 10, a pulse width modulator (PWM) 11, and an error amplifier 12 that detects at least one output parameter and controls the operation of the PWM 11 based on the detected output parameters. An output parameter may typically be an output current, output voltage, output power, or similar quantity. Conventional detectors for output parameters may include use of comparators, resistor configurations, dedicated sense lines, etc. In any case, a regulation of the output current or voltage conventionally relies on a feedback type control loop. In FIG. 2, an input voltage V_{IN} is input to the power stage 10 which provides an output voltage V_{OUT} to a load. The present inventors have determined that an open loop configuration may be used in certain applications, so that the FIG. 2 configuration is simplified.

Accordingly, a power supply of the present invention may be configured without measuring or sensing of output parameters. As shown in FIG. 3, a power stage 20 may be implemented in a power supply configuration that does not require a feedback type control loop. A pulse width modulation (PWM) type control box 21 is therefore able to control the operation of the power supply without using output parameters.

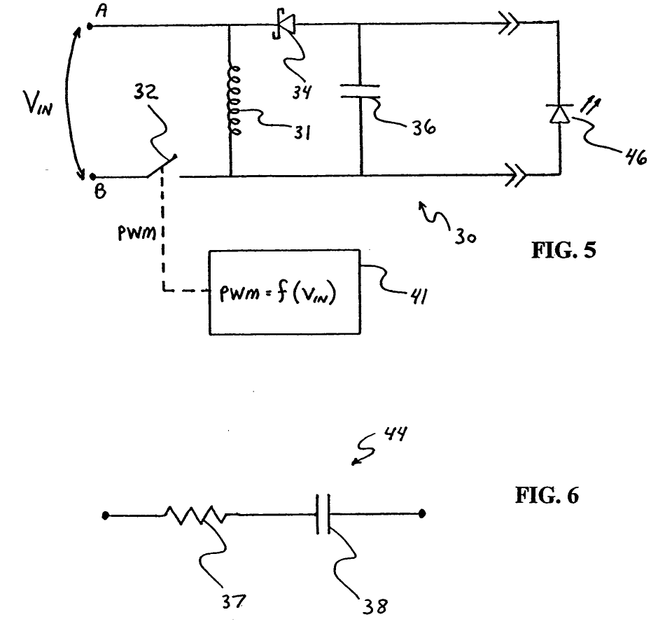

FIGS. 4 and 5 illustrate an exemplary preferred embodiment of the present invention. FIG. 4 illustrates how a voltage V_{IN} may be applied to the power supply circuit 30. The input voltage V_{IN} is measured and the measured voltage is used by the control box 41 to control operation of the power supply 30. In a preferred embodiment, the voltage measuring uses the control box 41 which includes a central processing unit (CPU) (not shown) having an analog-to-digital (A/D) converter. The A/D converter receives an analog voltage via associated signal conditioning parts from a voltage source such as, for example, a battery or batteries. It is noted that there are many ways for implementing an operation having effectively a same result as that obtained by an A/D converter operation. For example, a resistor-capacitor (RC) circuit along with a comparator and a timer may be substituted for an A/D converter. In the preferred embodiment, it is convenient to convert the measured input voltage V_{IN} to digital form so that the PWM=f(V_{IN}) computation is easily implemented. As will be further discussed below, the method may alternatively be effected in a partially or completely analog manner.

FIG. 5 shows a schematic of a power supply 30 in a buck-boost configuration according to an exemplary embodiment of the present invention. A voltage V_{IN} is applied across a pair of terminals A, B. In this example, a plus voltage is applied to terminal A and a negative voltage is applied to terminal B. When the voltage V_{IN} is being provided by one or more batteries, the connection from battery terminals to the A, B terminals may be made using any known system including, for example, compartments, springs, clips, soldered wires, connectors, integral connection, etc., alone or in any combination. The negative voltage applied to terminal B is fed to a power switch 32. The switch 32 is operative to connect or disconnect the B voltage to one end of the inductor 31, to one end of the capacitor 36, and to the anode of light-emitting diode (LED) 46. For purposes of description, the state where the B voltage is so connected may be referred-to as being the ON state, and the state where the B voltage is not so connected may be referred-to as the OFF state. The cathode of LED 46 is connected to the other side of capacitor 36 and also to the anode of diode 34, shown in this example as a Schottky type diode. The cathode of diode 34 is connected to the other side of inductor 31 and to the terminal A. The switch 32 is controlled by a control box 41. In this example, the controller 41 is shown as a pulse-width modulation (PWM) type controller.

In a preferred embodiment of the invention, a light such as a flashlight may be constructed using the FIG. 5 configuration. For example, the inductor 31 may be a 4.7 μH inductor having a part number DR74-4R7 and being available from Cooper Bussman, the switch 32 may be an N channel field effect transistor (FET) having a part number Si2312DS and being available from Vishay Siliconix, diode 34 may be a Schottky diode having a part number MBR0520 and being available from Motorola, capacitor 36 may be one or more individual capacitors of any appropriate type and has a value of 18 μF in one preferred embodiment, an exemplary load such as LED 46 may be an LED having a part number LXHL-PW01 and being available from Luxeon, and the controller 41 may include, inter alia, a microprocessor such as one having part number MPS430F1132 and being available from Texas Instruments. The diode 34 may also include a synchronous rectifier (not shown) disposed in parallel with a Schottky diode to reduce the forward voltage drop of the Schottky diode.

The synchronous rectification may be optionally employed as a method to improve efficiency and is embodied as a synchronous rectifier in parallel with diode 34. Synchronous rectification may also be effected by replacing a freewheeling diode with a low loss (low RDSₒₙ) MOSFET. In such a case, efficiency loss associated with the higher diode power dissipation due to the fixed forward voltage (VF) is reduced by the low RDSₒₙ of the MOSFET. The incorporation of synchronous rectification adds increased complexity in the controller 41 to ensure, for example, that MOSFET switches are not conducting at the same time. Cross-conduction leads to high shoot through currents and a decrease in efficiency. Other methods and structures for synchronous rectification may be employed in a power supply of the invention.

In various embodiments it may a be desirable to use a snubber circuit such as that shown by way of example in FIG. 6. As shown therein, a snubber circuit 44 includes a resistor 37 disposed in series with a capacitor 38. The snubber circuit 44 may be utilized to reduce or eliminate ringing, for example, due to a switching of the switch 32. Such a snubber may be disposed in a particular location in a power supply circuit depending upon the particular application. For example, a snubber circuit 44 may be placed in parallel with switch 32 and/or may be placed in parallel with inductor 31.

In choosing a particular inductor to be used in a given configuration, design considerations may include, inter alia, cost, input voltage, peak current, output power, space requirements, efficiency, electromagnetic effects and affectation (EMI/EMC), and acceptable PWM parameters. A DC resistance of a given inductor effects the efficiency of operation. Other parameters for the inductor include its basic value (μH), the core material(s) used and physical geometry (affecting saturation current and related characteristics, and frequency characteristics), shielding, and physical size.

In choosing a particular capacitor to be used, the design choice regarding the capacitor is typically affected by cost, space, and efficiency. The relevant capacitor parameters include basic value (μF), effective series resistance (ESR), dielectric material, and physical size. For example, a purpose of the capacitor 36 in FIG. 5 is to smooth-out the power pulses that result from the action of the circuit 30. This, in turn, is usually a desirable action as it regards the load, such as an LED load 46. However, if space and cost have a higher design priority compared with efficiency, and if the load will tolerate it, a capacitor such as, for example, capacitor 36 of FIG. 5 can be eliminated entirely. For example, when the load is an LED and when efficiency and reliability can be sacrificed in order to save cost and space, then a capacitor may be eliminated. The aforementioned reduction in reliability may occur when the LED is forced to conduct very high spike currents that are many times the maximum rated peak currents.

In choosing a particular diode to be used, the design choice is typically affected by cost, efficiency, and space. The relevant diode parameters include forward voltage drop, forward current, reverse voltage and recovery time. It is noted that, for the above-described example in which capacitor 36 is eliminated entirely (e.g., such as when efficiency has a lower priority), if the load has diode characteristics, a diode such as, for example, diode 34 of FIG. 5 can also be eliminated. Again, the aforementioned reduction in reliability occurs when the LED is forced to conduct very high spike currents that are many times the maximum rated peak currents.

In choosing a particular switch to be used, the design choice is typically affected by cost, efficiency, and space. The relevant switch parameters, for an example of an FET, include switching speed, switching current, switching voltage, and switching losses. The example of an FET is given by way of simplification in order to illustrate typical considerations in design, but the present invention is not thereby limited because various types of switch may be used according to the invention including, but not limited to transistors, tubes, relays, etc. In fact, any device that can be electronically turned on and off will be adaptable to the invention. Any number of individual switches configured in various arrangements may also be used for implementing a switch for use in an apparatus or method of the invention. Of course, a given device will have corresponding special requirements that must be accounted-for such as requirements for being driven. These special requirements may be related to design considerations for the other components of a given power supply.

In choosing a particular controller to be used, the design choice is typically affected by cost, the ability to drive a switch, and the ability to measure a voltage such as V_{IN}. The controller may be embodied in a single integrated circuit (IC) that performs all required tasks, or the controller may be a collection of parts. The PWM operation may include a computation that obtains a PWM transfer function directly by using a formula in real time. A controller operation may include using a look-up table of precalculated values with or without interpolation. A controller PWM operation may include an analog type computation. Any appropriate method may be used for generating a PWM transfer function (i.e., PWM=f(x)) and the invention is intended to incorporate any method for generating a PWM transfer function. An example of the aforementioned analog computation is: graphing a continuous waveform, adding a second line to the graph representing the input voltage; determining the time when the waveform is above or below the line as being the PWM waveform (e.g., detect this PWM waveform using a comparator); and, outputting the PWM waveform. Each of the graphed items may use a different scaling factor, and a scaling factor can be either linear or non-linear, as required for a particular application. For example, a part of such a non-linearity may be utilized for preventing a value from going too high or too low.

In designing a given power supply circuit, it is important to first determine the range of input voltages and the output power requirements. Then, an inductor should be chosen to transfer the required power across the full range of input voltages for a power supply operating in a discontinuous mode of operation under any expected load condition. This inductor selection may be accomplished using the formulas shown herein above by selecting an energy per cycle transfer and frequency to determine output power. The energy per cycle is a function of inductance, input voltage, and peak inductor current. The minimum time for a cycle is a function of the time required for the current to ramp up to peak, which is a function of inductance and input voltage plus the time required for the current to ramp back down to zero, which is a function of inductance, peak current, and output voltage. Limiting factors regarding the PWM frequency include the power supply's switching speed and a resolution of the switching, so that the inductor may be driven within a desired or permitted tolerance and with the required efficiency.

After selecting an inductance value and a PWM frequency, then the other component values are selected. The inductor 31 preferably has a low DC resistance and may also be shielded depending on a particular application. Switch 32 should be selected to be able to withstand the peak coil currents and have low losses including low switching transition losses. Diode 34 should have ratings suitable for desired performance under both peak and average currents, and should have a low forward voltage drop relative to the output voltage for good efficiency. Adding a synchronous rectifier (not shown) in parallel with diode 34 may be optionally provided for improving efficiency by lowering the forward voltage drop of the diode 34. The capacitor 36 should be chosen to have a sufficiently large capacitance value while having an effective series resistance (ESR) low enough to maintain ripple within desired limits.

The power supply may be used in any application where a constant power output with changing load conditions is required. However, the power supply should not be used when a constant voltage or a constant current under changing load conditions is required. It is noted that many existing applications drive a load with a constant current or a constant voltage supply when the particular application could instead have been driven using a constant power output power supply.

The amount of energy transferred in each cycle is a function of inductance, input voltage, and ON time. The ON time affects peak inductor current. In calibrating the power supply to achieve a desired performance, it is first considered that the inductor 31 for a given application may have, for example, a tolerance of plus/minus 20 percent. The input voltage measurement accuracy may have a typical tolerance of plus/minus 6 percent. The high speed oscillator and the ON time may have a large tolerance of plus/minus 50 percent. Therefore, in an uncalibrated system, peak current may have a tremendously large variation and the energy in the inductor 31 may have a variation proportional to a square of the peak current variation. As a result, it is advantageous to calibrate the power supply.

It may be desirable to maintain uniformity, for example, in a manufacturing of LED type flashlight, where there is minimal unit-to-unit variation in performance. If purchasers of flashlights expect individual flashlights to perform at a level of a best unit, then lesser performance may be seen as being a defective product. Quality control in flashlight manufacturing was previously not considered because there was little unit-to-unit variation in performance for an incandescent type flashlight. Since (uncalibrated) LED type flashlights may have significant unit-to-unit performance variation, binning may result in, for example, a 1.3:1 spread in light output. Such a range of performance is unacceptable for customers, so the present inventors recognized a need for calibration in LED flashlight manufacturing. By calibrating the LED flashlights' light intensity, the brightness is the same for all lights sold within a marketing group.

The following exemplary calibration steps and operations may be performed individually or as an interrelated process for the power supply, depending on a particular application. In the case of an LED flashlight, a process of assisted self-calibration may be used.

In a preferred embodiment, a first calibration concerns a PWM time base such as a high speed clock. A high-speed clock determines the ON time and the cycle frequency, and is a factor in determining the maximum switching resolution. The high speed clock is the timing element used in the PWM waveform generation in the preferred embodiment. Therefore, a known clock may be used to adjust the high speed clock, for example, to within 2 percent of a nominal value. Such an adjustment may be effected by only utilizing the software/firmware utilized by a CPU. For example, such a calibration adjustment may be implemented using a high quality slow speed clock that functions to time the high speed clock so that the calibration may be a self-contained operation without a need for external hookups. The tolerance chosen will of course depend upon requirements of a given application. When the high accuracy timing source is compared to the time base and a sufficiently accurate timing is produced, the corresponding hardware settings are retained and used to setup the PWM time base whenever the controller is restarted. If the high accuracy timing source is built into the controller, the controller can use the timing source to periodically account for temperature-induced offsets. The clock calibration may use a signal to time the PWM (high speed) clock until it finds a place where one adjacent setting is too slow and the next higher adjacent setting is too fast. For example, the calibrator may provide a clock signal such as a signal that toggles every 1/128 second. The processor counts the number of CPU cycles per toggle, compares the resultant count to, for example, a known CPU performance at a frequency of 5 MHz, and speeds up or slows down the 5 MHz clock until the counts are within a tolerance such as 5%.

In a preferred embodiment, a next calibration has an object of achieving a desired voltage measurement accuracy. Voltage measurement accuracy generally is related to part-to-part manufacturing variation as opposed to an over-temperature drift problem. Such calibration, for example, may apply a known input voltage and allow the power supply voltage measurement system to read the known input voltage. This provides a scaling factor/correction factor for all subsequent voltage measurement readings. It is assumed that a source of error in the power supply voltage measurement system is a reference voltage circuit and that this error produces a ratio-metric error in all voltage readings. Voltage calibration may assume a fixed voltage and merely calculate a correction factor based on the measured value to make it match the calibration value.

In the preferred embodiment, a next calibration concerns the inductor 31 itself. It is desired to compensate for differences in coil values. If the coil value is smaller than a nominal value, the peak currents will be higher and more energy will be transferred per cycle. If the coil value is larger than the nominal value, the peak currents will be smaller and less energy will be transferred per cycle. A smaller coil value is similar in effect to having a higher input voltage and a larger coil value is similar in effect to having a lower input voltage. The inductor typically has a fixed value, and the input voltage is a measured value of a voltage from an external voltage source. In one embodiment, a variable that contains the inductor's value is modified so that the formula contains an accurate inductor value. In another embodiment, adjustable parameters regarding the inductor itself are the ON time and the cycle frequency. While it may be impractical for some applications, it is also possible to utilize one or more variable inductor(s) in implementing a particular power supply application.

There are different ways to adjust time depending on which quantities/parameters are assumed to be fixed or non-changeable. For example, if it is assumed that the high speed clock is fixed, in an application that accesses a lookup table (LUT) and selects a value from the LUT based on voltage, a correction factor may be applied to the voltage that results in a “corrected for time” value being selected from the LUT. For example, if the value of inductor 31 is ten percent larger than a nominal inductor value that was the basis for the computations used for creating the LUT, an adjusting of the voltage reading by approximately ten percent compensates for the value of the inductor, effecting an increased ON time. A calibration may include measuring the input power while an adjusting or a compensating of the voltage is being performed, and communicating to the processor when a desired power has been achieved. The calibration of the clock and the calibration of the voltage measurement may be done in any order.

An alternative way to calibrate may include assuming that the LUT and the voltage value are fixed, so that the clock is made to be adjustable or is compensated-for. For example, if the inductor 31 is ten percent larger than a desired nominal value, the clock speed may be slowed by approximately ten percent to compensate for the inductor value, which will increase the ON time and reduce the frequency. This alternative may be less desirable for certain applications because it may be necessary to over-compensate the ON time to make-up for the also extended OFF time. Calibration in such an alternative embodiment includes measuring input power while the clock is being adjusted or compensated-for, and communicating to the processor when the desired power has been achieved.

Another alternative is to assume that the high speed clock is fixed and to periodically or continually adjust the value of the inductor in real time where, for example, a value of the inductor is actually measured for determining a formula to be used in the subsequent adjusting of the value. Calibration in such an embodiment includes measuring input power while adjusting the inductor value used in the formula, and communicating to the processor when a desired power has been achieved.

Calibrating the output power in a preferred embodiment may include merely calibrating the input voltage and the high speed clock. Calibrating the output power may also be achieved by other methods. For example, if an output voltage is obtained and a dummy resistor load is connected to the output, the power supply can be adapted to calibrate itself (e.g., V²*R). Alternatively, for example, when an output power accuracy is only required to be approximately a same accuracy as the coil, then no calibration is necessary.

In an exemplary embodiment of calibrating, the input current is measured at a known voltage, and the ON time and/or the OFF time are adjusted. In this manner, for example, the PWM clock parameters are adjusted to obtain a peak output power.

An actual adjusting of the PWM clock for a calibration, for example, may be problematic in a case where both ON time and OFF time are simultaneously adjusted because it is possible to adjust the OFF time in a wrong direction. The above-described method for using a LUT and adjusting only an ON time may be advantageous in a practical sense, where an adequate but still imperfect level of performance is obtained. By implementing the calibration using the LUT in real time, an excellent calibration of the PWM clock may be achieved because both the ON time and the OFF time may be adjusted in harmony.

In a preferred embodiment, the only parameter being adjustable is time. This adjustment of the PWM clock is used to adjust/compensate-for other parameters such as peak current (a function of time), input voltage, and inductance. In the preferred embodiment, the input voltage and inductance themselves are non-adjustable as far as the circuit is concerned. It is noted that the frequency, as described herein, is defined as 1/(ON time+OFF time).

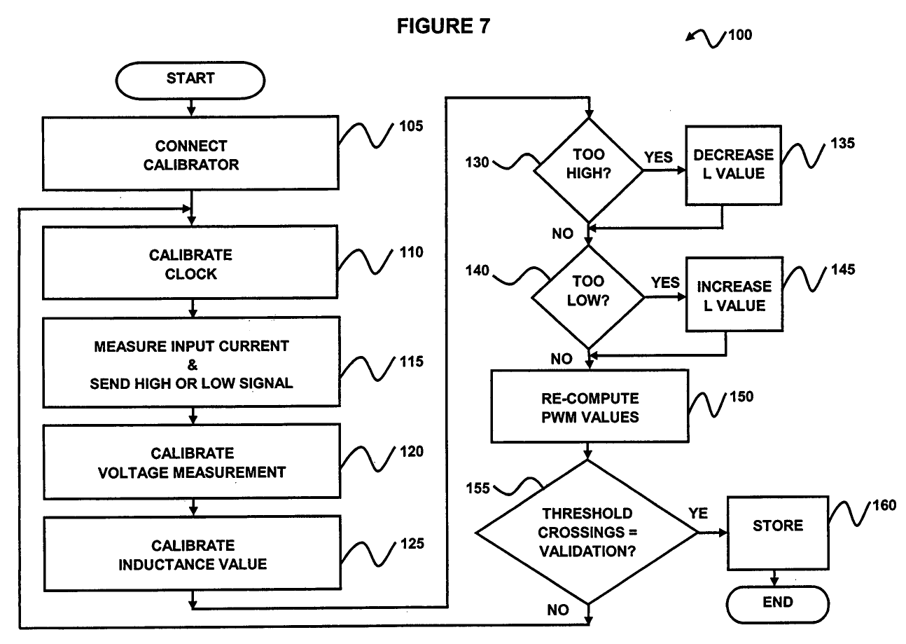

FIG. 7 illustrates a calibration method according to an exemplary preferred embodiment. In step 105, a calibration system (not shown) is hooked up to the power supply being calibrated, the calibration system providing a standard DC input voltage of 3.0 volts. In step 110, the power supply calibrates the high speed clock using a high quality low speed clock (not shown) that is a part of the power supply circuit. An example of this clock calibration is discussed hereinabove. In step 115, the calibration system measures the input current and signals either a ‘too low current’ or a ‘too high current’ state to the power supply using a signal contact. The power supply then calibrates the voltage measurement in step 120 using the 3.0 V input voltage as a reference. For example, the power supply may use the ‘state’ signal from the calibrator to select a voltage value from an LUT disposed within the power supply and repeat the lookup process according to a predetermined set of rules for re-selecting a new voltage value from the LUT. Step 125 involves calibrating the coil inductance by running the power supply and looking at the same current state signal from step 115 as was used for step 120. If the current state signal indicates that the current is too high in step 130, then the inductance value used in the subsequent formula is decreased in step 135. If the current state signal indicates that the current is too low in step 140, then the value of the inductance for use in the formula is increased in step 145. The power supply then re-computes the PWM values in step 150 according to the appropriate formula. The controller 41 keeps track of the crossings of the high and low thresholds that are indicated by the current state signal from step 115. When these threshold crossings satisfy an appropriate rule used by the processor, then the controller 41 determines in step 155 that an accurate reading has been validated, and the result of the PWM value(s) computation is stored in step 160 and the calibration is complete. If the validation does not occur in step 155, then the calibration method repeats the calibration process in whole or in part, depending on an appropriate set of rules. In the FIG. 7 example, the process is repeated by returning to step 110.

The power supply may be implemented in a flashlight that uses an LED as the light source. In such a case, the brightness of the LED itself may also be calibrated, although this calibration may or may not be related to a calibration of the power supply itself. One example if such a calibration includes reading a brightness value from a light intensity meter positioned opposite the LED, obtaining a brightness high/low signal in a manner similar to step 110 discussed above, and performing a calibration according to a methodology essentially similar to steps 125 to 160 described above.

It is noted that three signals described above, namely the reference 3.0 V signal, the current high/low state signal, and a brightness high/low signal are each always available within the calibration apparatus, so that no operator interaction with the system is required. The entire calibration process for the preferred embodiment may be performed within a few seconds. The calibration may be totally automated. When an operator is used for loading and unloading a flashlight into a calibration station, the software of the calibrator or the firmware in the controller 41 may cause the light to blink twice, for example, when a calibration has been completed.

The preferred flashlight embodiment runs the PWM clock between 70 Hz and 100 KHz depending on the brightness setting. The high speed clock typically runs at 5 MHz and provides a PWM resolution of 200 ns. Such parameters typically provide a 1000:1 brightness range.

Regarding frequency, the use of a higher frequency of operation for the PWM are size, weight and lower DC resistance in the coil. Accuracy of output, lower idle power and lower switching losses are among reasons to use a lower PWM frequency. This trade-off, as well as cost and availability may dictate a choice of operating frequency. Generally, as technology improves and becomes less expensive, the frequencies used in various designs rise.

Regarding ringing, all power supplies typically require a small amount of dampening. When the inductor 31 of the FIG. 5 example runs out of power (i.e., inductor current goes to/through zero) its voltage is still high. This results in a pushing of current in the opposite direction. Switch 32 and diode 34 both have some capacitance so that, in combination with inductor 31, an LC circuit is formed that oscillates (“rings”). The snubber circuit, shown by way of example in FIG. 6, spoils the quality factor Q of the circuit and prevents/limits the circuit from ringing by dissipating the small amount of energy remaining.

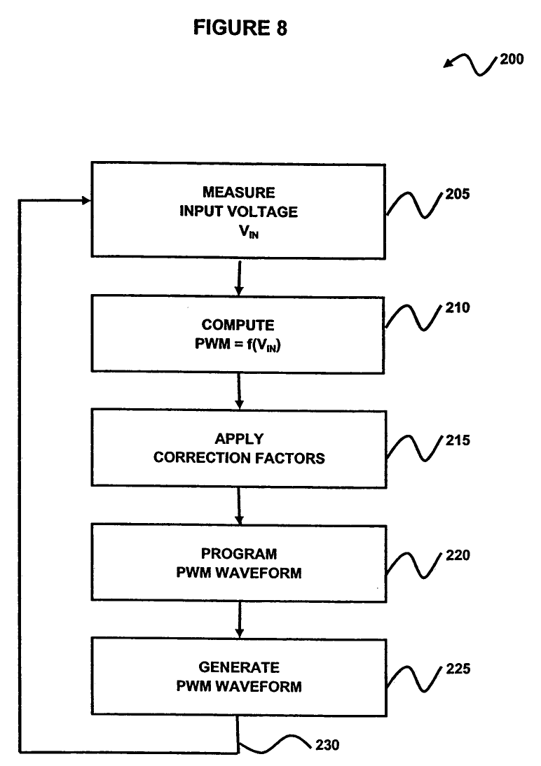

The controller 41 operation 200 is illustrated in FIG. 8. First, the input voltage is measured in step 205. For example, as shown in FIGS. 4 and 5, the input voltage V_{IN} is measured across the inductor 31 and switch 32. Any known manner of measuring the input voltage may be used, and the resultant V_{IN} may be either an analog measurement or a digital value depending on a particular application. Using this measured V_{IN}, the PWM value(s) are then calculated in step 210. This calculation provides the ON time and the OFF time needed to generate the PWM waveform. “PWM-time” is equal to the ON time plus the OFF time. As discussed herein above, this calculation may be accomplished by real-time calculations, by using an LUT, or by using a partially or fully analog method. The calculation may include a step 215 applying correction factors obtained from a calibration process such as those discussed above. Usually, such application of correction factors will be implemented as a part of the measurement of V_{IN} in step 205 and/or as part of the calculation of PWM value(s) in step 210. For example, voltage correction factor(s) are preferably applied when the voltage is measured. However, it is also possible to implement additional correction factors independently of measuring and/or computing. In step 220, the ON time and the OFF time may be used to program the PWM waveform. In a preferred embodiment, however, such programming is not required since the calculated PWM values from step 210 may be used for directly generating the actual PWM output in step 225. A separate programming step 220, when desired, may be accomplished either in hardware or in software. As used herein, the term “software” may be used to describe any computer type instructions written to be performed on hardware, including, e.g., firmware. Many different types of hardware may be used to accomplish the PWM operation, and any appropriate PWM apparatus may be used. Generally, the PWM hardware includes a clock that generates a clock signal, a tick, a periodic waveform, etc. For example, a timer is set to reset itself every PWM-time ticks of the clock. Whenever the timer resets, it puts the PWM output into a known state (e.g., a “1” or a “0”). A register is compared to the timer and when they are equal, the state of the PWM output is forced to change or toggle. Therefore, as the clock ticks, it alternately changes the PWM output from 1 to 0 and back to 1, etc. in sequence. When this operation is performed in software, the software may use CPU instruction sequences, which have a known time between instructions, to set and clear the PWM output state. Step 225 involves generating the PWM waveform. The PWM waveform is routed to the switch electronics, and the PWM waveform causes the switch 32 to turn ON or OFF. The switch 32 is preferably a transistor, and a switching of a transistor is well known and not described further herein. The PWM operation 200 is repeated periodically, preferably several times per second. A time between PWM cycles is shown in FIG. 8 as reference numeral 230. This time 230 may be actively implemented, or may be accounted for due to constraints such as switching speed, ringing, voltage measurement time, etc. The voltage V_{IN} should be measured often enough to assure that the output power remains within the specified limits, so that the controller 41 is able to compensate for a given rate of change in the input voltage V_{IN}. It is noted that the method may be an analog type method, whereby several steps may be eliminated.

It is also noted that in PWM, the time of occurrence of either the leading or trailing edge of each pulse (or both) may be varied from its unmodulated position by samples of the modulating wave. For example, the modulating wave may be produced by step 220. The samples may be obtained based on a sampling principle where a continuous message waveform having a spectrum of finite width can be recovered, for example, from a set of discrete instantaneous samples whose rate is higher than twice the highest signal frequency.

An exemplary embodiment uses one or more batteries as a source of electric power. A battery generally can be viewed as a voltage source in series with a resistor. Therefore, as the current consumption goes up, the voltage goes down in direct proportion. The amount of “internal” resistance in a battery depends on the battery chemistry and the state of charge/discharge of the battery. Alkaline batteries have a much higher internal resistance compared with lithium batteries or rechargeable batteries, especially later in the discharge cycle. The internal resistance goes up as the battery discharges. Batteries with a steep discharge curve, e.g., alkaline batteries, also have a significant internal resistance that grows steadily throughout the life of the battery. Batteries having more of a flat discharge curve, e.g., lithium and rechargeable batteries, have a lower internal resistance that grows relatively slowly throughout the life of the battery.

By measuring the input voltage V_{IN} many times per second, the battery voltage changing over time and load is compensated-for by the controller 41. For any given power, there is a minimum voltage below which it becomes impractical or impossible to supply the desired or requested power. As the voltage goes down, the ON time increases up to the limits imposed by the particular application. Below the minimum voltage, the ON time remains fairly constant, which has the effect of automatically reducing the output power as the voltage continues to drop. As the voltage drops by a factor of “n”, the output power drops by the square root of n. For example, in a typical performance of the preferred embodiment, a ten percent drop in voltage results in a 32 percent drop in power.

For the aforementioned preferred embodiment used in a flashlight application, the minimum voltage selected is chosen to minimize or prevent damage to rechargeable batteries. The system using batteries degrades gracefully—as the minimum voltage is measured for a present power setting, the power supply acts to reduce the power to the next lowest setting level. This process of reducing the power to subsequently lower levels is repeated until the power supply is operating at a lowest level or setting. Below the lowest level, the operating situation is deemed to be critical. In this case, a particular design may implement a rule where keeping the light turned on has priority over saving the rechargeable batteries, such as for the following example. The flashlight application of a preferred embodiment contains a real-time clock that, for example, is set to tick approximately 32 times per second. When the situation is critical and V_{IN} is below the critical voltage (e.g., less than 2 volts), the power supply turns off the power for one tick of the clock and then turns the power back on to the lowest setting. When the low battery condition first begins to occur, the battery recovers and the off periods are separated, for example, by one or two minutes. Eventually, as the battery wears down, the voltage never recovers, in which case the off periods may only be separated by only one tick worth of light. When the above-mentioned rule allows the light to continue in this manner, the voltage will drop so low that there is no light visible. This may take several hours, depending on a particular battery type used. However, the CPU of the preferred embodiment will still have enough power to continue to function. Such behavior is intended to provide a safety feature, in that the user receives adequate warning regarding the condition of the batteries since the final remaining percentage of the battery life will last for hours.

A particular application implements a constant power switching power supply 30 in a flashlight that uses one or more LEDs as its light source and one or more batteries as its source of electric power. Alternatively, a converter such as, for example, a known cigarette lighter type adapter for a motor vehicle may be used in a source of electric power being provided to the power supply of the flashlight. An on/off switch (not shown) is provided in the flashlight system so that a user can turn the light on and off. The actual location of the on/off switch within the flashlight can vary according to the particular application, and may be disposed in series in the flashlight circuit or, alternatively, can be an input to the controller 41 in a case where the controller 41 effectively shuts off switch 32 by being activated by the user's on/off switch.

As the size and weight of a miniature flashlight becomes smaller, it is increasingly important to improve electrical efficiency and reduce heat. By regulating output power without measuring output parameters, an elimination of the conventional sense resistor and associated electronics or similar apparatus provides reduced weight, cost, heat, and space, and the power consumption of such a sense resistor is thereby eliminated so that flashlight efficiency is increased. Other advantages may be realized depending on various factors such as accuracy and tolerances, performance characteristics, temperature effects, reliability, etc. Therefore, while it is known to provide an LED driver circuit having a PWM output, conventional systems typically use current feedback to adjust power to LED arrays, and do not realize the various advantages just described.

The exemplary embodiments disclosed herein have been described for the purpose of applying novel aspects of the invention to particular illustrative uses. Although preferred embodiments have been shown and described, a great deal of modifications, changes, substitutions, deletions, or additions may be made by a person having skill in the art without departing from the spirit and scope of the invention.

1. A constant-power switching power supply comprising an inductor having an inductor current that operates exclusively in discontinuous conduction mode (DCM),
wherein the power supply is operative to supply and maintain constant output power to a load without measuring output parameters of the power supply, by regulating charge-up time of the inductor.

2. A power supply as claimed in claim 1, further comprising:
a voltage measurement unit operative to measure an input voltage being provided to the power supply; and
a pulse-width modulation (PWM) generator operative to perform the regulating of the charge-up time based on the measured input voltage.

3. A power supply as claimed in claim 1, the power supply having an input voltage and being configured in a buck-boost topology, the power supply further comprising:
a look-up table for translating the input voltage into a set of values; and
a pulse-width modulation (PWM) generator operative to perform the regulating of the charge-up time based on the set of values.

4. A power supply as claimed in claim 3, further comprising a voltage measurement unit structured for periodically measuring the input voltage, wherein the set of values is updated for each periodically measured input voltage.

5. A power supply as claimed in claim 1, further comprising a switch and a pulse width modulation (PWM) generator operative to drive the switch, thereby effecting the regulating,
wherein the power supply has a buck-boost topology.

6. A power supply as claimed in claim 5, further comprising a voltage measurement unit structured for periodically obtaining a measured input voltage, wherein the driving of the switch is based on the measured input voltage.

7. A power supply as claimed in claim 6, further comprising at least one battery that supplies the input voltage to the voltage measuring unit.

8. A power supply as claimed in claim 5 and further comprising a load, the power supply supplying essentially constant power to the load, the power supply further comprising a capacitor disposed in parallel with the load.

9. A power supply as claimed in claim 5 and that supplies essentially constant power to a load, the power supply further comprising a diode disposed in series with a current being supplied by the inductor to the load.

10. A power supply as claimed in claim 6, wherein the PWM generator is operative to drive the switch in a manner tailored for a case where the load comprises a semiconductor device.

11. A power supply as claimed in claim 6, wherein the PWM generator is operative to drive the switch in a manner tailored for a case where the load comprises at least one light emitting diode (LED).

12. A power supply as claimed in claim 9, further comprising a memory operative to translate the measured input voltage into a set of values.

13. A power supply as claimed in claim 12, wherein the memory comprises a look-up table.

14. A power supply as claimed in claim 13, wherein the memory comprises a processor.

15. An apparatus comprising:
a voltage source that provides a voltage having polarity of plus and minus;
a constant-power power supply having a buck-boost topology and comprising:
a switch having a first terminal and a second terminal, the switch connected to the plus voltage at the first terminal;
an inductor having one end connected to the second terminal of the switch and having an other end;
a capacitor having one end connected to the one end of the inductor and having an other end;
a diode having a cathode connected to the other end of the capacitor and having an anode connected to the other end of the inductor and to the minus voltage; and
a control box operative to obtain a value based on a measurement of the voltage, and to operate the switch for regulating charge-up time of the inductor based on the value; and
a load connected across the capacitor;
wherein the inductor has an inductor current that remains in discontinuous conduction mode (DCM), and wherein the regulating of the charge-up time of the inductor provides an essentially constant power to the load.

16. An apparatus as claimed in claim 15, wherein the voltage source comprises at least one battery.

17. A power supply for supplying essentially constant power to one or more LEDs, comprising:
an inductor;
means for measuring input voltage being applied to the power supply;
means for generating a pulse width modulation (PWM) signal based on the measured input voltage, the PWM signal having in a cycle of operation an ON portion, an OFF portion, and an IDLE portion;
means for storing energy in the inductor during the ON portion;
means for discharging energy from the inductor to the one or more LEDs during the OFF portion; and
a load that receives the energy discharged from the inductor as output power of the power supply;
wherein the means for storing energy in the inductor effects regulating of the output power without measuring output parameters of the power supply.

18. A method of maintaining a constant output power for a power supply being run in discontinuous conduction mode (DCM), having an inductor, comprising:
obtaining a measured input voltage for voltage being input to the power supply;
obtaining from a memory a set of values based on the measured input voltage; and
driving a pulse width modulation (PWM) generator based on the set of values, the driving of the PWM generator thereby regulating a charge-up time of the inductor to correspond to the measured input voltage,
whereby the regulating of the charge-up time of the inductor maintains an essentially constant power for a load.

19. A method as claimed in claim 18, wherein the obtaining of the set of values from the memory comprises accessing a look-up table for translating the measured input voltage.

20. A method as claimed in claim 18, wherein the power supply has a buck-boost topology.

21. A method as claimed in claim 20, wherein the load is a predetermined load that comprises at least one light emitting diode (LED).

22. A method of supplying constant power from a power supply to one or more LEDs, the power supply having an inductor, the method comprising:
measuring input voltage being applied to the power supply;
generating a pulse width modulation (PWM) signal based on the measured input voltage, the PWM signal having in each cycle of operation an ON portion, an OFF portion, and an IDLE portion;
storing energy in the inductor during the ON portion; and
discharging energy from the inductor to the one or more LEDs during the OFF portion;
whereby the storing of energy in the inductor effects regulating of output power being supplied to the one or more LEDs without measuring output parameters of the power supply.

23. A method as claimed in claim 22, wherein the generating comprises controlling durations of the ON and OFF portions of the PWM signal cycles.

24. A method as claimed in claim 22, further comprising controlling frequency of the PWM signal based on the measured input voltage.

25. A method as claimed in claim 22, wherein the power supply has a buck-boost topology.

26. A method as claimed in claim 22, wherein the power supply has a boost topology, the method further comprising:
obtaining an error value corresponding to each cycle; and
accumulating error values for a number of consecutive cycles of operation.

27. A method of regulating the output power of an inductor type switching power supply, the power supply having an input voltage, the method comprising:
obtaining a value of the input voltage; and
regulating the ON time (charge-up time) of the inductor to correspond to the value of the input voltage so as to store a certain amount of energy in the inductor,
whereby the regulating of the ON time of the inductor effects regulating of the output power without measuring output parameters of the power supply.

28. A method as claimed in claim 27, further comprising determining the certain amount of energy that corresponds to a particular input voltage by defining a load for the output power being produced.

29. A method as claimed in claim 27, wherein the obtaining a value of the input voltage comprises measuring the input voltage.

30. A method as claimed in claim 27, wherein the regulating of the ON time of the inductor comprises:
translating the value of the input voltage to obtain a set of values;
generating a pulse width modulation (PWM) signal based on the set of values; and
driving a switch using the PWM signal.

31. A method as claimed in claim 30, further comprising adjusting the translating based on a determination of at least one time constant value for the power supply.

32. A method as claimed in claim 31, wherein the time constant value is based on an inductance value of the inductor.

33. A method of providing electric power to a semiconductor device, the method comprising:
providing an open loop power supply configured in a buck-boost topology and having a shunt inductor;
measuring an input voltage of the power supply;
providing a translator that is operative to translate the measured input voltage into a set of values; and
adjusting a duty cycle of the electric power being provided to the semiconductor device based on the set of values.

34. A method of controlling a constant power, switching power supply that operates in an open-loop configuration, the power supply having a switch that is turned on and off by pulse width modulation (PWM), the method comprising:
graphing a value to obtain a first waveform;
adding a line to the first waveform representing the input voltage;
determining the time when the first waveform is above or below the line as being a PWM waveform; and
outputting the PWM waveform.

35. A method as claimed in claim 34, wherein the determining comprises detecting using a comparator.

36. A method as claimed in claim 34, wherein the graphing further comprises applying a scaling factor to the first waveform.

37. A method for calibrating a constant-power switching power supply having an inductor with an inductor current that operates exclusively in discontinuous conduction mode (DCM), the power supply being operative to supply and maintain constant output power to a load without measuring output parameters of the power supply, by regulating charge-up time of the inductor, the power supply having a voltage measurement unit that obtains a measured voltage being input to the power supply, the power supply having a PWM time base, the method comprising comparing a timing source having a known frequency to the PWM time base, thereby obtaining at least one time correction factor.

38. A method for calibrating as claimed in claim 37, further comprising applying an input voltage having a known value to the power supply and computing a voltage correction factor based on a difference between the known value and a value obtained from the voltage measurement unit.

39. A method for calibrating as claimed in claim 37, wherein the comparing comprises timing a high speed clock using a slow speed clock.

40. A method for calibrating as claimed in claim 37, wherein the method is a self-contained operation not requiring external hookups.

41. A method for calibrating as claimed in claim 37, further comprising determining hardware settings for the power supply based on the at least one time correction factor.

42. A method for calibrating as claimed in claim 41, further comprising retaining the hardware settings and using the hardware settings to setup the PWM time base whenever the controller is restarted.

43. A method for calibrating as claimed in claim 37, further comprising adjusting the measured voltage reading by a factor that compensates for a value of the inductor, thereby changing an ON time of the inductor.

44. A method for calibrating a flashlight having a buck-boost power supply that operates in discontinuous conduction mode (DCM) and that includes at least one light emitting diode (LED) as its source of illumination, the method comprising:
positioning a brightness measurement unit to oppose the at least one LED;
varying an operating parameter of the power supply;
obtaining a brightness measurement of the at least one LED from the brightness measurement unit; and
repeating the varying and obtaining until a predetermined condition is met.
